(19) United States
(12) Patent Application Publication
(10) Pub. No.: US 2012/0089508 A1
(43) Pub. Date: Apr. 12, 2012

(54) Methods and Systems for Inter-Currency Transfers

(75) Inventors: Adrian Lindbom, Karlskrona (SE); Goran Loncaric, Karlskrona (SE)

(73) Assignee: TELEFONAKTIEBOLAGET L M ERICSSON (PUBL), Stockholm (SE)

(21) Appl. No.: 12/969,213

(22) Filed: Dec. 15, 2010

Related U.S. Application Data
(60) Provisional application No. 61/407,586, filed on Oct. 28, 2010.
(60) Provisional application No. 61/392,236, filed on Oct. 12, 2010.

(51) Int. Cl. G06Q 40/00

(52) U.S. Cl. 705/40

(57) ABSTRACT

Exemplary embodiments describe systems and methods which provide for currency or inter-currency transfers. An intermediate broker operates between service providers to enable the transfer to be separated into two local e-money transactions from point of view of the service providers. E-money flows and real money flows are disassociated to enable, for example, beneficiary parties to receive their funds in real time (or near real time) and to enable the intermediate broker to aggregate real money flows during periodic rebalancing processes among its local accounts.

### TECHNICAL FIELD

The present invention relates generally to transaction systems and methods and, in particular, to methods and systems for performing inter-currency transfers.

### BACKGROUND

As technology advances, the options for communications have become more varied. For example, in the last 30 years in the telecommunications industry, personal communications have evolved from a home having a single rotary dial telephone, to a home having multiple telephone, cable and/or fiber optic lines that accommodate both voice and data. Additionally cellular phones and Wi-Fi have added a mobile element to communications.

To accommodate the new and different ways in which IP networks are being used to provide various services, new network architectures are being developed and standardized. One such development is the Internet Protocol Multimedia Subsystem (IMS). IMS is an architectural framework which uses a plurality of Internet Protocols (IP) for delivering IP multimedia services to an end user. A goal of IMS is to assist in the delivery of these services to an end user by having a horizontal control layer which separates the service layer and the access layer. IMS provides a standardized way to deliver telephony, data and multimedia conferencing services over fixed and mobile IP networks.

As people are provided with more, and varying, services, convenience and ease-of-use are becoming more convenient selling factors given the breadth of competitive service offerings. One such service area involves monetary transactions. Banking systems tend to lag the general economy with respect to the implementation of high technology service solutions due to, for example, security concerns associated with the specific service offerings of their business sector. For example, current e-money systems involve isolated components which typically have individual negotiated connections between one end user's Financial Service Provide to other Financial Service Providers which use proprietary interfaces. Thus international remittance typically involves, for example, a Sending Financial Service Provider performing an international money transfer to a Receiving Financial Service Provider.

As shown conceptually in FIG. 1, the current Financial Service Provider implementations thus typically require multiple connections in order to provide support for international remittance towards several other Financial Service Providers (SP1-SP5). This arrangement places requirements on each Financial Service Provider (FSP) implementation to support different interfaces and remittance methods. International remittance of funds is highly regulated, time consuming and non-trivial to perform. For example, the Sending Financial Service Provider is required to perform anti-money laundering (AML) checks on the Receiving Financial Service Provider, the corridor and the receiving end-consumer. Moreover, each Financial Service Provider must cater for the real money movement including international transfers and forecasts. As a result of forecasted transactions, the Sending Financial Service Provider (sFSP) must invest funds in the Receiving Financial Service Provider (rFSP) to cover the transactions during the period of the forecast. These funds are tied up with the risk that the actual value of the funds can decrease due fluctuation of currencies, meaning that the Sending Financial Service Provider takes the risk of currency exchange. Additionally, the Sending Financial Service Provider takes the risk that funds will be stuck at the Receiving Financial Service Provider for non-convertible currencies.

Accordingly, it would be desirable to provide systems, methods and software to facilitate inter-currency transfers.

### SUMMARY

Exemplary embodiments describe systems and methods which provide for currency or inter-currency transfers. An intermediate broker operates between service providers to enable the transfer to be separated into two local e-money transactions from point of view of the service providers. E-money flows and real money flows are disassociated to enable, for example, beneficiary parties to receive their funds in real time (or near real time) and to enable the intermediate broker to aggregate real money flows during periodic rebalancing processes among its local accounts.

According to one exemplary embodiment, a method for performing inter-currency transactions by a remittance information broker (RIB) server, includes the steps of receiving, at the RIB server from a first financial service provider (FSP), a transaction request signal for an inter-currency transaction, the inter-currency transaction to be performed from a remitting party in a first currency to a beneficiary party in a second currency which may be different from the first currency, determining, by the RIB server, that a valid corridor exists between the first FSP and a second FSP associated with the beneficiary party, transmitting, by the RIB server, preliminary information toward the first FSP, the preliminary information including a remittance amount in the first currency needed to perform the inter-currency transaction, receiving, by the RIB server, a signal indicating that the remittance amount in the first currency has been deposited into a first RIB account held by an FSP in a same jurisdiction as the first FSP and accessible by the RIB server, transmitting, by the RIB server, an execution signal toward a second FSP authorizing transfer of a remittance amount in the second currency which corresponds to the remittance amount in the first currency from a second RIB account held by an FSP in a same jurisdiction as the second FSP and accessible by the RIB to a beneficiary account held by the second FSP and accessible by the beneficiary party, determining, by the RIB server, a transfer amount needed to provide a balance in the second RIB account which is at least equal to forecasted inter-currency transactions to be performed from the second RIB account during a predetermined time period, and transmitting, by the RIB server, a rebalancing signal to initiate transfer of funds into the second RIB account for the transfer amount.

According to another exemplary embodiment, a remittance information broker (RIB) server which handles inter-currency transactions includes: an interface configured to transmit signals to a network and configured to receive signals from the network, the interface further configured to receive a transaction request signal from a first financial service provider (FSP) for an inter-currency transaction, the inter-currency transaction to be performed from a remitting party in a first currency to a beneficiary party in a second currency which is different from the first currency, a processor configured to validate a corridor between the first FSP and the second FSP and further configured to transmit preliminary information toward the first FSP, the preliminary information including a remittance amount in the first currency needed to perform the inter-currency transaction, wherein the interface is further configured to receive a signal indicating that the remittance amount in the first currency has been deposited into a first RIB account held by an FSP in a same jurisdiction as the first FSP and accessible by the RIB, wherein the processor is further configured to transmit an execution signal toward a second FSP authorizing transfer of a remittance amount in the second currency which corresponds to the amount in the first currency from a second RIB account held by an FSP in a same jurisdiction as the second FSP and accessible by the RIB to a beneficiary account held by the second FSP and accessible by the beneficiary party, and wherein the processor is further configured to determine a transfer amount needed to provide a balance in the second RIB account which is at least equal to forecasted inter-currency transactions to be performed from the second RIB account during a predetermined time period and to transmit a rebalancing signal to initiate transfer of funds into the second RIB account for the transfer amount.

According to still another exemplary embodiment, a method for performing inter-currency transactions by a financial service provider (FSP) server associated with a first FSP includes the steps of receiving, at the FSP server, a remittance signal from a remitting party's device requesting an inter-currency transaction to be performed toward a beneficiary party, the inter-currency transaction to be performed from the remitting party, having an account held by the FSP, in a first currency to a beneficiary party in a second currency which is different from the first currency, the beneficiary having an account with a second FSP, transmitting, by the FSP server, a transaction request signal for the inter-currency transaction toward a remittance information broker (RIB) server, receiving, at the FSP server, a corridor validation signal including preliminary information including an amount in the first currency needed to perform the inter-currency transaction from the RIB server's perspective, transmitting, by the FSP server, a signal indicating a total amount needed to perform the inter-currency transaction toward the remitting party's device, receiving, by the FSP server, a user authorization signal to execute the inter-currency transfer, transmitting, by the FSP server, a signal indicating that the amount in the first currency has been deposited into a first RIB account held by an FSP in a same jurisdiction as the first FSP and accessible by the RIB, receiving, by the FSP server, an execution response signal indicating that an amount in the second currency which corresponds to the amount in the first currency has been transferred from a second RIB account held by an FSP in a same jurisdiction as the second FSP and accessible by the RIB to a beneficiary account held by the second FSP and accessible by the beneficiary party, and periodically receiving, by the FSP server, a rebalancing signal to transfer funds into or out of the second RIB account.

According to still another exemplary embodiment, a financial service provider (FSP) server associated with a first FSP which handles inter-currency transaction includes an interface configured to receive a remittance signal from a remitting party's device requesting an inter-currency transaction to be performed toward a beneficiary party, the inter-currency transaction to be performed from the remitting party, having an account held by the FSP, in a first currency to a beneficiary party in a second currency which is different from the first currency, the beneficiary having an account with a second FSP, a processor configured to transmit a transaction request signal for the inter-currency transaction toward a remittance information broker (RIB) server, wherein the interface is further configured to receive a corridor validation signal having preliminary information including an amount in the first currency needed to perform the inter-currency transaction from the RIB server's perspective, wherein the processor is further configured to transmit a signal indicating a total amount needed to perform the inter-currency transaction toward the remitting party's device, wherein the interface is further configured to receive a user authorization signal to execute the inter-currency transfer, and wherein the processor is further configured to transmit a signal indicating that the amount in the first currency has been deposited into a first RIB account held by an FSP in a same jurisdiction as the first FSP and accessible by the RIB, wherein the interface is further configured to receive an execution response signal indicating that an amount in the second currency which corresponds to the amount in the first currency has been transferred from a second RIB account held by an FSP in a same jurisdiction as the second FSP and accessible by the RIB to a beneficiary account held by the second FSP and accessible by the beneficiary party, and wherein the interface is further configured to periodically receive a rebalancing signal to transfer funds into or out of the first RIB account.

### BRIEF DESCRIPTION OF THE DRAWINGS

The accompanying drawings illustrate exemplary embodiments, wherein:

FIG. 1 depicts interconnections between financial service providers which were conventionally needed to provide inter-currency transaction capability;

FIG. 2 illustrates an inter-currency transaction system at a conceptual level according to an exemplary embodiment;

FIG. 3(a) depicts e-money transfers associated with inter-currency transfers according to an exemplary embodiment;

FIG. 3(b) shows real money transfers associated with inter-currency transfers according to an exemplary embodiment;

FIGS. 4(a)-4(d) are signaling diagrams depicting different phases of inter-currency transfers according to an exemplary embodiment;

FIG. 5 shows various functions performed by a remittance information broker (RIB) server according to an exemplary embodiment;

FIG. 6 depicts exemplary signaling associated with pre-funding rebalancing according to an exemplary embodiment;

FIG. 7 depicts an exemplary server according to an exemplary embodiment;

FIG. 8 is a flowchart illustrating a method for performing inter-currency transactions by a (RIB) server according to an exemplary embodiment;

FIG. 9 is a flowchart illustrating a method for performing inter-currency transactions by a financial service provider (FSP) server according to an exemplary embodiment; and

FIG. 10 depicts interconnections between financial service providers via a RIB server according to an exemplary embodiment.

### ACRONYM LIST

| | |
|---|---|
| AML | Anti-Money Laundering |
| CD-ROM | Compact Disk-Read Only Memory |
| CRT | Cathode Ray Tube |
| DVD | Digital Video Disk |
| FSP | Financial Service Provider |
| GAN | Generic Access Network |
| IMS | IP Multimedia System |
| IP | Internet Protocol |
| LCD | Liquid Crystal Display |
| OTP | One Time Password |
| PROM | Programmable Read Only Memory |
| rFSP | Receiving Financial Service Provider |
| RIB | Remittance Information Broker |
| sFSP | Sending Financial Service Provider |
| SMS | Short Messaging Service |

### DETAILED DESCRIPTION

The following detailed description of the exemplary embodiments refers to the accompanying drawings. The same reference numbers in different drawings identify the same or similar elements. Also, the following detailed description does not limit the invention. Instead, the scope of the invention is defined by the appended claims.

According to exemplary embodiments, real time (or near real time) inter-currency transfers can be performed between a remitting party and a beneficiary party without, for example, the above-described drawbacks and limitations in a manner which is easier both for the Financial Service Providers (FSPs) and the end users. This can be accomplished by, for example, establishing a Remittance Information Broker (RIB) server as an intermediary system node which is, according to exemplary embodiments, disposed between the FSPs and which handles many of the tasks which would otherwise need to be handled by individual and proprietary systems between each of the FSPs.

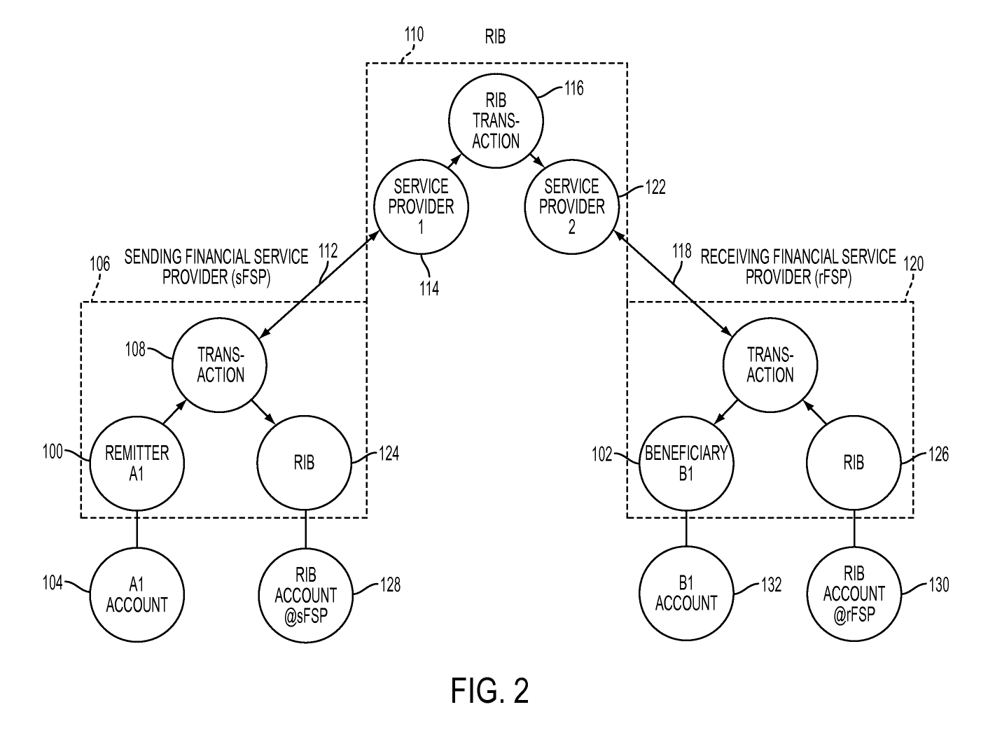

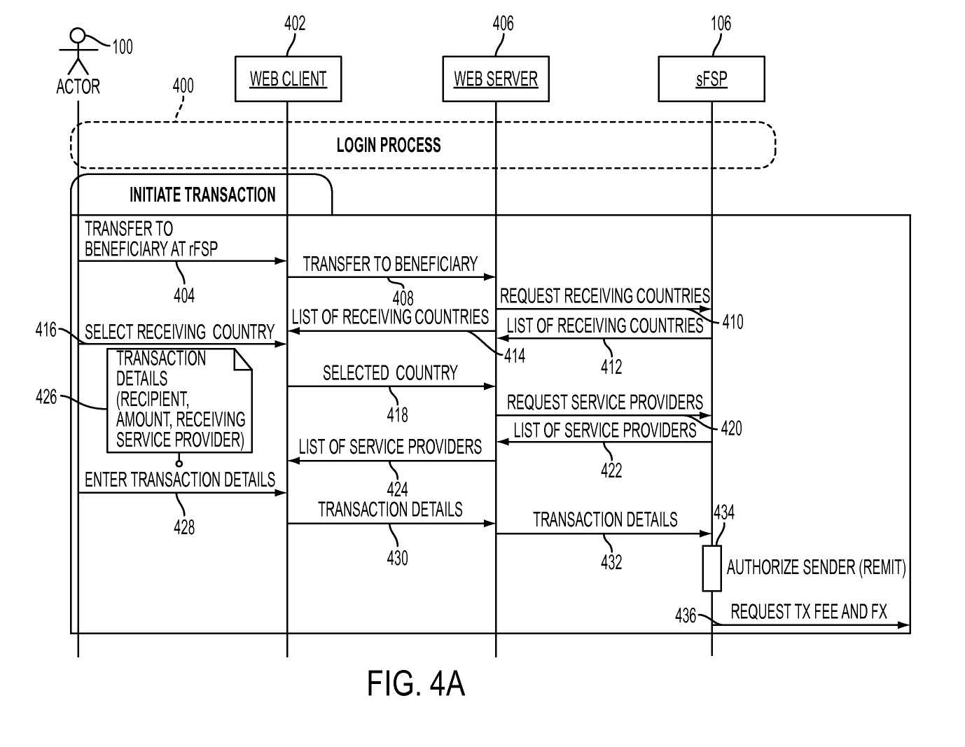

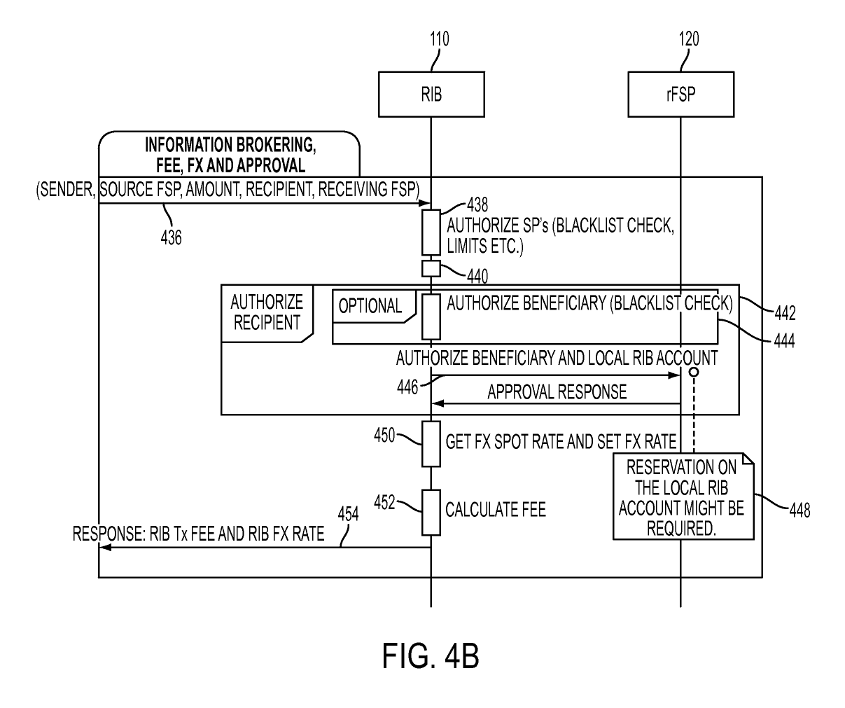

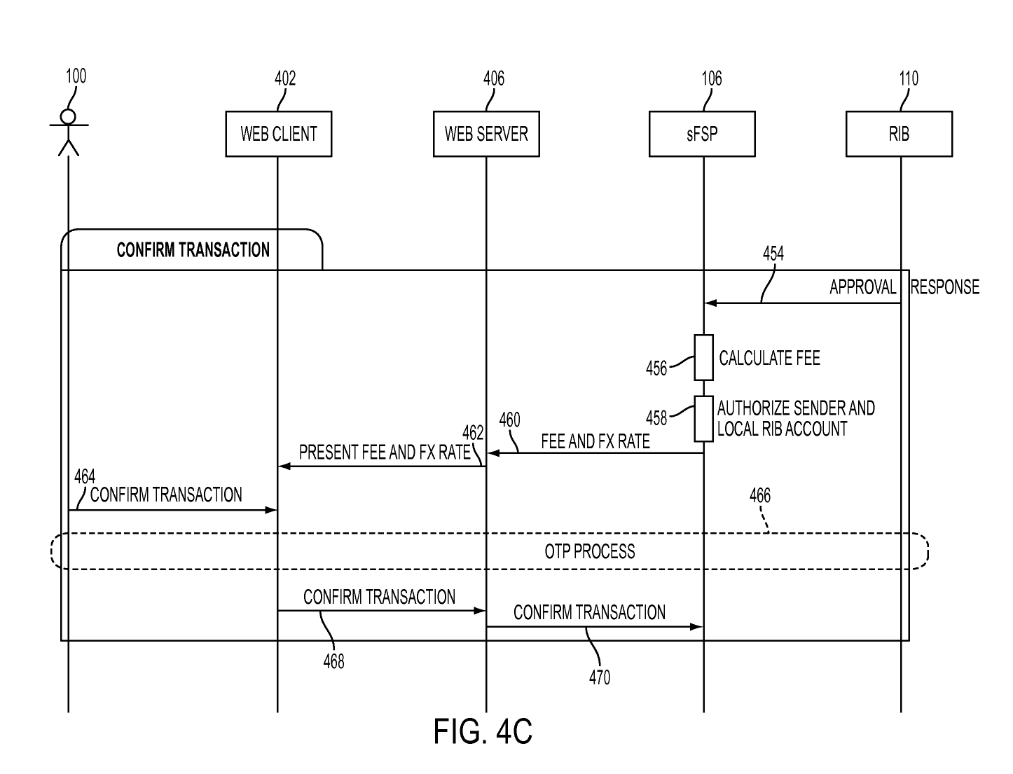

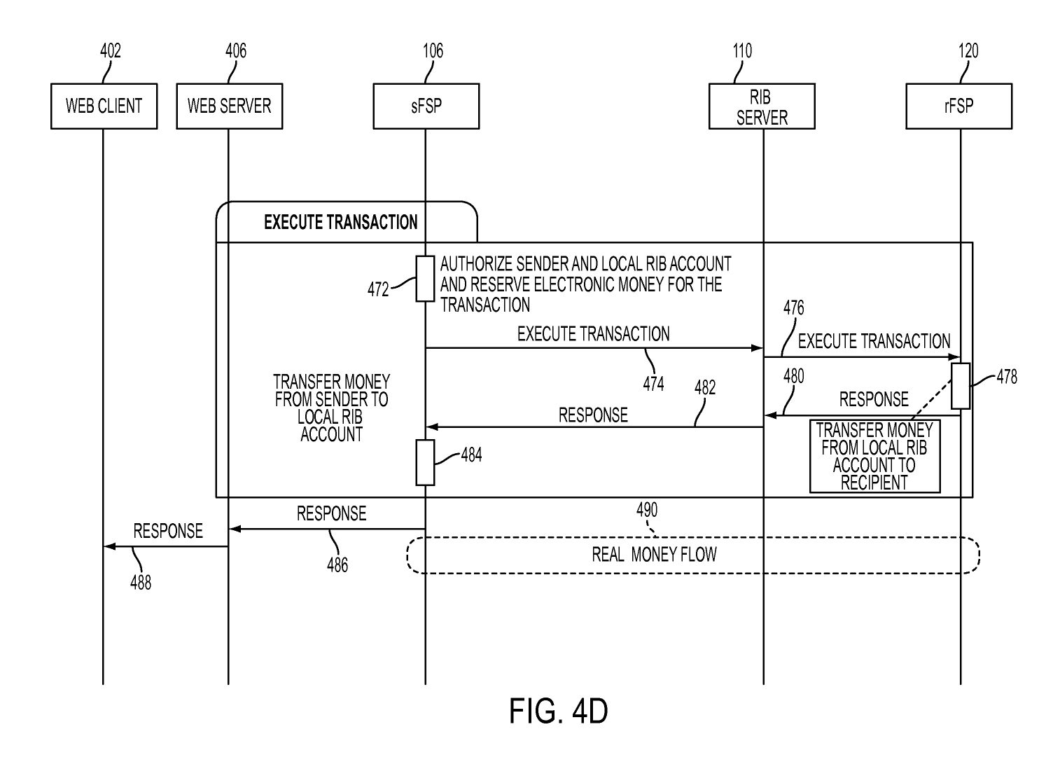

Consider the illustrative system for inter-currency transactions according to an exemplary embodiment which is shown in FIG. 2. In this example, suppose that a remitting party 100 wants to transfer the equivalent of 100 euros to a beneficiary party 102 in US dollars. The remitting party 100 has an account 104 with an FSP 106, in this example FSP 106 is referred to as the Sending FSP (sFSP) since it is the entity from which the remitting party is initiating the inter-currency transaction. When the remitting party initiates the transaction 108, various signaling is performed between the sFSP 106 and the RIB server 110 as indicated generally by arrow 112. A more detailed example of this signaling 112 is discussed below with respect to FIGS. 4(a)-4(d). However from the point of view of the sFSP 106, transaction 108 is a local transaction between the remitting party 100 and the RIB 124, such that the transaction 108 can be performed using legacy systems which are already available to sFSP 106.

The RIB server 110 can have an interface or port 114 associated with signaling towards and from sFSP 106. This signaling initiates a RIB server transaction 116 associated with the requested inter-currency transaction and includes transaction details including the amount of the requested transfer, identity of the beneficiary party, identity of the remitting party, etc. The RIB 110 is able to move money from one FSP to another and is, therefore, aware of the available transaction corridors, the limits on those corridors and the rules associated with performing transactions via such corridors. A remittance corridor is the path (through the RIB) connecting a specific pair of financial service providers (FSPs) which can be located in different countries, cities, and/or networks. Preferably, a remittance corridor should, to be valid, comply with appropriate (financial) rules and regulations. Among other things, the RIB server transaction will involve signaling 118 toward a receiving FSP (rFSP) 120 via interface or port 122 at which the beneficiary party 102 has an account 132. This signaling 118 is also discussed below in detail with respect to FIGS. 4(a)-4(d). As in the sending side, on the receiving side the transaction is a local transaction, i.e., from the RIB 126 to the beneficiary 102.

The RIB is thus also a recognized entity by each of the sFSP 106 and the rFSP 120 as indicated by blocks 124 and 126, respectively. More specifically, the RIB has accounts or wallets 128 and 130 accessible by the sFSP 106 and rFSP 120, respectively, which are accessible by the RIB server 110 to enable inter-currency transfers according to these exemplary embodiments. Accounts 128 and 130 are prefunded by actions initiated by the RIB server 110 associated with forecasted transactions in a manner which will be described below with respect to FIG. 4(d).

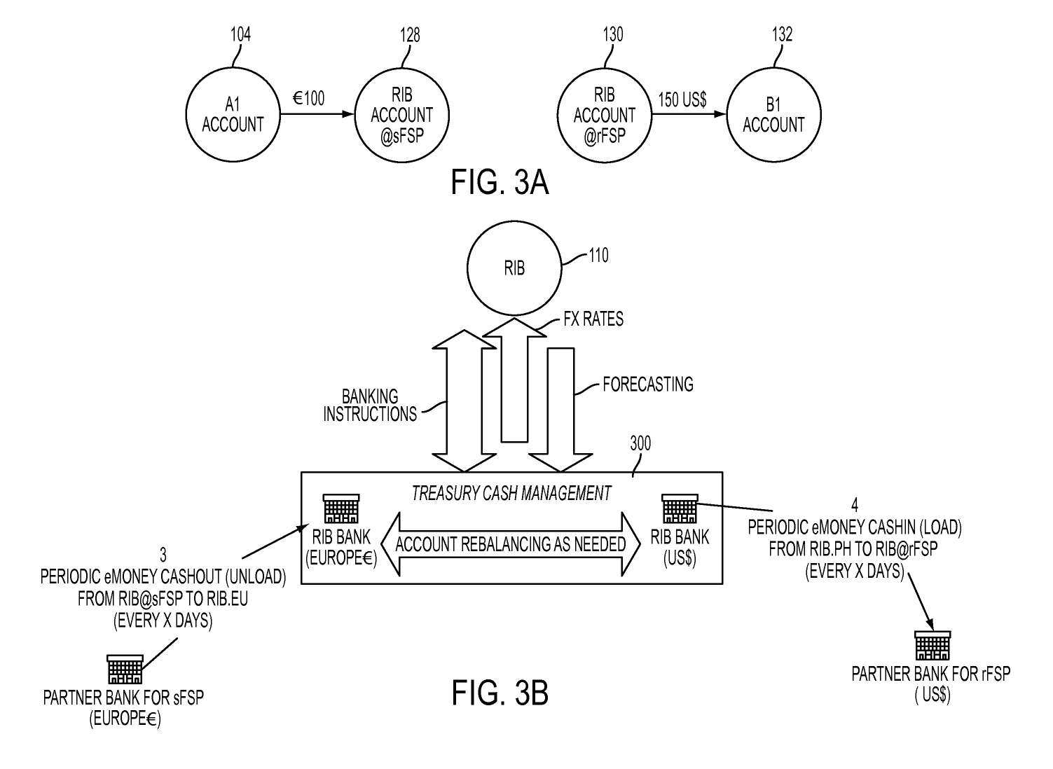

The exemplary inter-currency transfer between the remitting party 100 and the beneficiary party 102 which is performed by the system of FIG. 2 can be described in the context of its associated e-money transfer and real money transfer. From an e-money flow perspective, the exemplary transaction in FIG. 2 involves the transfer of 100 euros from the remitting party's account 104 into the RIB account 128 in the sFSP 106, and the transfer of 150 dollars, i.e., an equivalent amount to 100 euros for a given exchange rate, from the RIB account 130 at the rFSP 120 into the beneficiary's account 132. These two e-money transfers are performed as a result of extensive signaling between various entities in the system as will be described below. However it is important to note here that exemplary embodiments perform inter-currency transfers in a manner which disassociates the e-money transfers of FIG. 3(a) from their corresponding real money transfers to enable, among other things, for real time (or near real time) access to the transferred funds by the beneficiary party 102 without the need for a bank settlement of the real money.

That is, since the RIB server 110 is facilitating inter-currency transfers using its own, pre-funded accounts, it becomes possible to enable the immediate transfer of available funds from a remitting party to a beneficiary party without awaiting the later transfer of real money to settle the transaction. The real money flows, as shown for example in FIG. 3(b), can be aggregated and performed later (and periodically), which also enables a reduction in overall costs for the system. The RIB server 110 can, for example, interact with a treasury cash management system 300 to perform a rebalancing of funds in its own accounts held by the various FSPs in the system to ensure that sufficient funds are available to handle forecasted inter-currency transactions, in a manner described below, but need not do so in synchronism with the e-money flows for individual inter-currency transactions. In this example, a refunding process is performed from the sFSP in Europe toward the rFSP in the United States, e.g., to replenish the RIB account 130 as a result of a number of these transactions.

To provide some additional detail regarding these exemplary embodiments, exemplary signaling performed between the various servers (nodes) in the system of FIG. 2 will now be described with respect to FIGS. 4(a)-4(d). Starting with FIG. 4(a), a login process 400 is performed whereby the remitting party 100 obtains access to a user interface, e.g., via a web client 402 operating on a mobile phone (or any other type of mechanism, not necessarily web-based or device), from which she or he can initiate an inter-currency transfer. This login process 400 can involve any desired interactions, e.g., pointing a browser to a link where the web client is running, entering user name and password, etc. Once the user interface is available, the remitting party enters one or more inputs into the user interface to start the transaction as generally indicated by arrow 404. The transaction initiation request is, in this exemplary embodiment, forwarded from the web client 402 to a web server 406.

The web server 406, in turn, forwards the transaction initiation request to sFSP 106, i.e., a server associated with sFSP 106, to request a list of receiving countries to which inter-currency transfers are currently available via signal 410. Alternatively, both blocks 406 and 106 can be considered to be part of an FSP, where the web server 406 is the front-end component and an inter-currency transaction application operates as the back-end component. sFSP server 106 returns a list of available, receiving countries via signal 412 to the web server 406 which forwards the list on to the web client 402 for presentation to the remitting party 100 via signal 414. According to this exemplary embodiment, the remitting party first selects the receiving country toward which the inter-currency transfer is desired, e.g., the United States from the previous example, and a corresponding signal is sent via signals 416 and 418 to the web server 406. The web server 406 then requests a list of FSPs which are available in the selected country via signal 420 from the sFSP 106.

The sFSP 106 returns a list of service providers in the selected country which are available for an inter-currency transaction via signal 422. The web server 406 forwards the list to the web client 402 via signal 424 which can then present them to the user on the user interface of his or her terminal device or other device via which the remitting party 100 is accessing the inter-currency transfer system. The user then selects a receiving FSP in the selected country to perform the inter-currency transfer, and enters any other necessary details for the transaction, e.g., recipient identity, amount, etc as indicated by block 426 and arrow 428. These transaction details are transmitted from the web client 402 to the web server 406 via signal 430, and from there on to the sFSP server 106 via signal 432.

Upon receipt of the transaction details, the sFSP server 106 can perform an authorization process 434 to determine whether the remitting party 100 is authorized to perform the requested inter-currency transaction. Assuming that the authorization process 434 is successful, the sFSP 106 transmits a transaction request signal for an inter-currency transaction toward the RIB server 110, e.g., for an inter-currency transaction to be performed from a remitting party in a first currency to a beneficiary party in a second currency which is different from the first currency. As will be described in more detail below, other exemplary embodiments are not limited to inter-currency transfers, i.e., between two different currencies, as those skilled in the art will appreciate that the techniques described herein can be used in a similar manner to transfer e-money in the same currency. Moreover, the initiation of the transaction described above with respect to FIG. 4(a) is purely illustrative and it will be appreciated that the transaction details needed by the RIB server 110 can be obtained and processed in a number of different ways as between a remitting party 100 and an sFSP 106 prior to sending such details toward RIB server 110.

In any event, once the RIB server 110 receives the transaction request signal 436, e.g., including information which identifies: the sender (remitter), sFSP, amount to be transferred and rFSP, as shown in FIG. 4(b), the inter-currency transfer according to this exemplary embodiment then involves various aspects of information brokering, fee determination, foreign exchange rate determination and approvals. For example, as indicated by block 438, the RIB server 110 determines whether the sFSP 106 and rFSP 120 are authorized to perform the requested inter-currency transfer. For example, the RIB server 110 checks applicable blacklists and transfer limits to ensure that the requested transaction does not violate any transaction rules. Additionally, as indicated by block 440, RIB server 110 validates the corridor between the remitting party 100 and the beneficiary party 102. This validation involves checking to see if the route between the sFSP 106 and rFSP 120 is a valid route. If the identity of the rFSP 120 is not explicitly signaled to the RIB server 110 in the transaction request signal, it may still be possible to determine the relevant beneficiary network for corridor validation. For example, the beneficiary may be identified by its mobile number in the transaction request signal. If so, the RIB server 110 can identify the beneficiary's network based on the mobile number prefix, and perform corridor validation between the sFSP and the identified beneficiary network in this way. Alternatively, if the beneficiary is identified by his or her email address, then the RIB server 110 can, for example, assume that a default email-based FSP, e.g., PayPal, is the entity toward which corridor validation should be performed. Other corridor validation techniques are also possible.

Once the RIB server 110 has performed these checks to determine the validity of the requested transaction, it can then perform certain steps to authorize the transaction on the recipient (beneficiary) side as indicated generally by block 442. For example, and optionally, the RIB server 110 can authorize the beneficiary party 102 itself, e.g., by checking blacklists, etc., as shown by block 444. The RIB server 110 can also authorize this transaction on the beneficiary side by contacting the rFSP 120 via signal 446 to request approval of the beneficiary and/or to confirm that sufficient funds are present in its account 130 to perform the requested transaction. The rFSP 120 may, or may not, reserve the funds in RIB account 130 needed to make the inter-currency transfer, as indicated by block 448. Once an approval signal is received by RIB server 110, the RIB server 110 can obtain the foreign exchange spot rate, e.g., to exchange 100 euros into Philippine pesos at a particular time, and set an exchange rate for this transaction, e.g., possibly including a markup to the current spot rate and/or a risk factor for changes in the spot rate between the setting of the rate and the actual time of the transaction, as indicated by block 450. Additionally, the RIB server 110 can calculate its own fee for performing the inter-currency transaction at block 452. The resulting preliminary information, e.g., a remittance amount in the first currency (e.g., euros in this example) including the amount to be transferred, the RIB fee and the foreign exchange rate, can then be transmitted back toward the sFSP 106 via signal 454.

Turning now to FIG. 4(c), upon receiving the approval response signal 454 (which can also operate as part of the corridor validation process 440), the sFSP server 106 can, for example, calculate its own fee for the inter-currency transaction (step 456) and authorize the sender's account 104, as well as the local RIB account 128 for this transaction (step 458). The sFSP 106 can then transmit a signal 460 including a total amount needed to perform the inter-currency transaction toward the web server 406, e.g., including the determined overall fee and foreign exchange rate. This signal 460 can be forwarded on to the remitting party's device via signal 462, to present all of the finalized transaction information to the remitting party for confirmation. If approved, the remitting party initiates a confirmation (step 464) and, according to this exemplary embodiment, an optional one time password (OTP) authentication process 466 may be performed to add security to the transaction. If, for example, the inter-currency transaction is being performed by the remitting party 100 via his or her mobile phone, then the optional OTP process 466 can be performed by transmitting an SMS message. In any event, once the end user's device has performed any optional authentications that are required by its currency transfer client application, the device (in this exemplary embodiment represented by web client 402) transmits a confirmation signal 468, which is forwarded by web server 406 via signal 470, to the sFSP server 106.

Turning now to FIG. 4(d), once the inter-currency transfer has been authorized by the remitting party 100, the sFSP server 106 can take any additional steps needed to finalize the transaction from the sending side, e.g., authorize the remitter's local account 104 and the RIB local account 128 (if not performed previously in step 458) and reserve e-money in the remitter's local account 104, as indicated by block 472. According to some exemplary embodiments, it may be sufficient for sFSP server 106 to reserve e-money in the remitter's local account 104 for later transfer to the local RIB account 128. Alternatively, according to other exemplary embodiments, it may be necessary for the sFSP 106 to actually perform the e-money transfer from the remitter's local account 104 to the RIB local account 128, i.e., by depositing the amount needed to complete the transaction in the first currency (e.g., euros) into the RIB account 128 held by the sFSP 106 (or by another FSP in a same jurisdiction as FSP 106), prior to transmitting an execution signal 474 toward the RIB server 110.

The RIB server 110 then sends an execution signal 476 toward the rFSP 120 authorizing the transfer of the remittance amount in the second currency (e.g., 150 dollars) from the RIB account 130 to the beneficiary account 132. Upon receipt of this signal 476, the rFSP 120 performs the requested transfer from RIB account 130 to the beneficiary account 132, and transmits a response signal 480 toward the RIB server 110 confirming that the transaction has taken place. The RIB server 110, in turn, sends an execution response signal back toward sFSP server 106 indicating that the amount in the second currency has been transferred to the beneficiary's account 132. If the sFSP server 106 has not already actually performed the e-money transfer between the remitter's account 104 and the local RIB account 128, e.g., if it had previously reserved but not transferred the funds in the first currency (e.g., 100 euros) for this inter-currency transaction, then the actual e-money transfer can be performed upon receipt of the execution response signal 482 as shown by block 484. A confirmation of the completed inter-currency transaction can then be returned to the remitting party via signals 486 and 488.

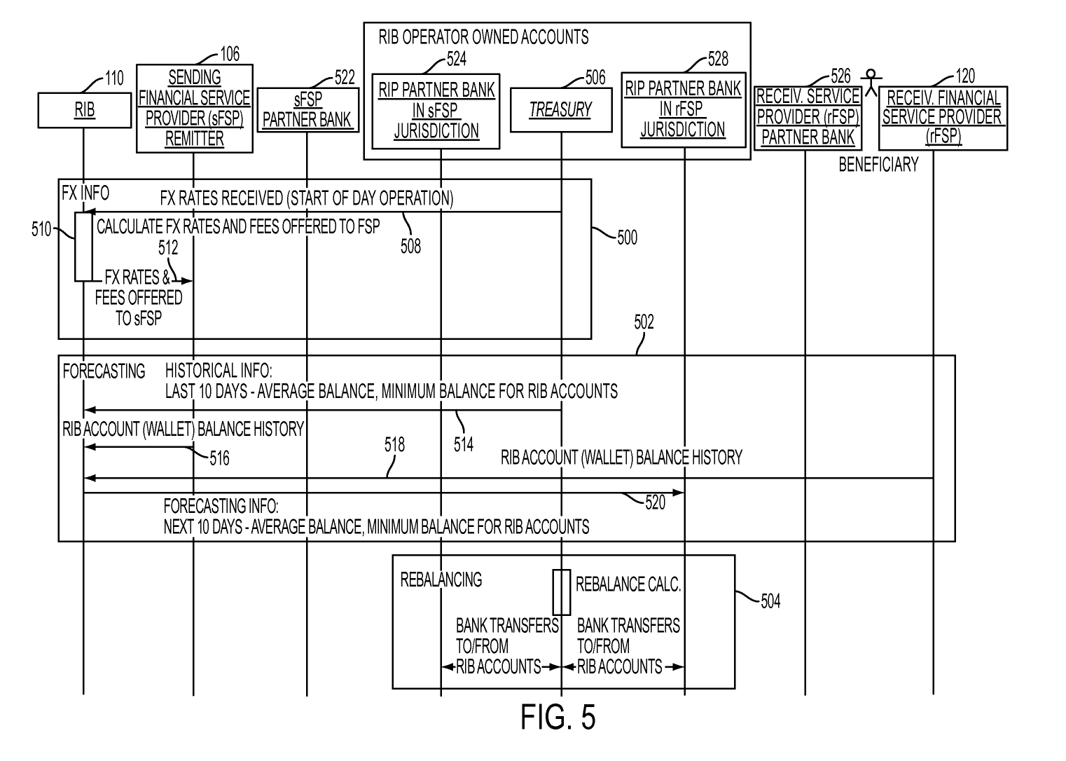

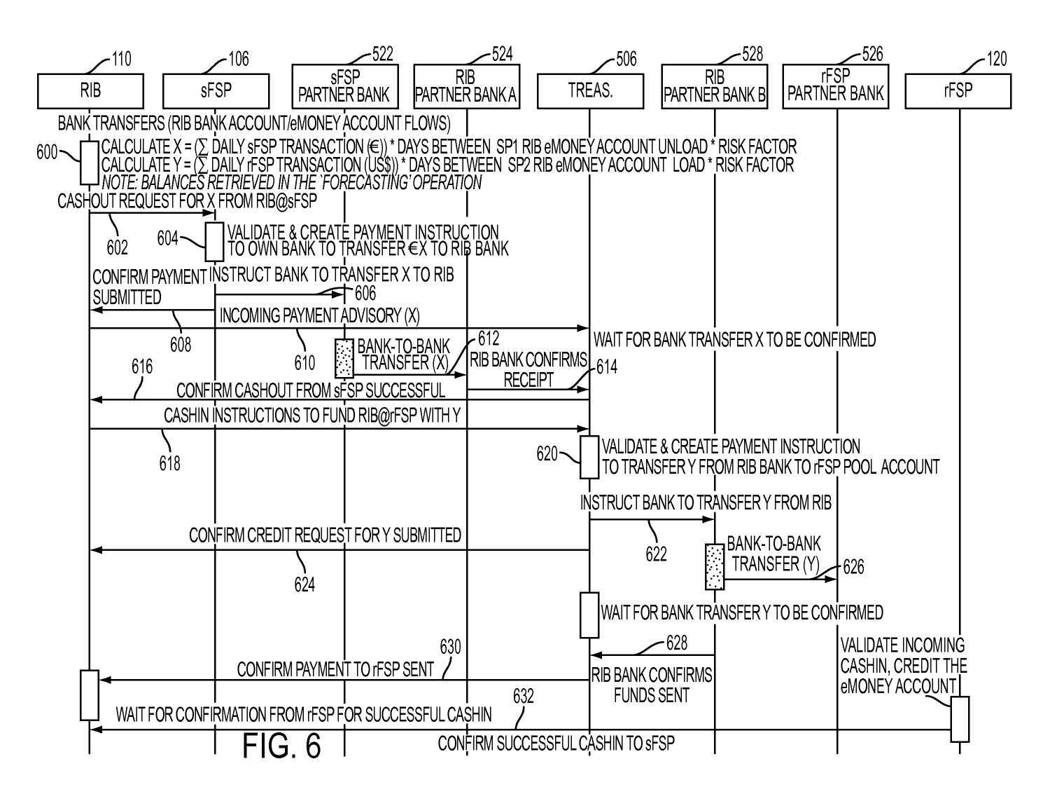

As mentioned above, since the RIB 110 represents an intermediary having pre-funded local accounts at the FSPs involved in the inter-currency transaction, the beneficiary will have immediate access to his or her funds which were received via the transaction, without needing to await a bank settlement associated with the movement of real money associated with the transaction. Instead, the real money flows used to re-balance the various RIB accounts, e.g., accounts 128 and 130, can be performed later and can involve the aggregation of various e-money transactions which have been performed and/or are anticipated to be performed in the future. This function is generically represented by the block 490 in FIG. 4(d) and will now be described below with respect to FIGS. 5 and 6.

Starting with FIG. 5, three different functions which are routinely performed by, or initiated by, the RIB server 110 according to exemplary embodiments are shown, i.e., receipt and processing of foreign exchange rates 500, forecasting of balances in the various RIB accounts 502 and rebalancing of the various RIB accounts 504. For example, each day the RIB server 110 can receive a new set of foreign exchange rates from a Treasury account 506 held by the RIB via signal 508. The RIB server 110 can calculate the corresponding exchange rates and fees which it will offer to the various FSPs which are participating in its inter-currency brokerage service as indicated by block 510 and can transmit this information as needed to each sFSP, e.g., sFSP 106, via signal 512. This function 500 supports the signaling 454 described above that provides the remitting party 100 with information regarding how the requested inter-currency transaction will be implemented in terms of its exchange rate, e.g., transferring 100 euros will yield 150 dollars to the beneficiary.

Turning now to forecasting 502, the RIB server 110 can periodically, e.g., daily or every predetermined number of days, receive historical data which enables it to forecast various parameters associated with the local RIB accounts, e.g., RIB account 128 and 130, that are used in the rebalancing process. For example, as shown in FIG. 5, the RIB server 110 can receive historical information from the Treasury 506 about the average balance and minimum balance associated with each RIB account via signal 514. Additionally, the RIB server 110 can receive balance history information for the RIB accounts 128 and 130 from their respective FSPs 106 and 120 via signals 516 and 518, respectively. Using this information, the RIB server 110 can calculate forecasting information, e.g., anticipated average balance and minimum balance for each of the RIB accounts, e.g., RIB account 128 and 130, associated with forecasted inter-currency transactions to be performed during a next predetermined time period, e.g., the next 10 days. This information can be transmitted by the RIB server 110 back to the Treasury 506 as a rebalancing signal 520 which functions to initiate the transfer of funds into or out of RIB accounts.

This rebalancing function is generally illustrated in block 504, and will be more specifically discussed below with respect to FIG. 6. Prior to discussing FIG. 6, however, some other entities which are illustrated in FIG. 5 and used in FIG. 6 shall first be identified. While it is possible for the various accounts illustrated in FIG. 2, e.g., accounts 104, 128, 130 and 132, to be directly held by the sFSP 106 and rFSP 120, it may alternatively be the case that these accounts are actually maintained by different banks which are in the same jurisdiction as the FSP, and which are accessible by the FSP as well as the respective account owner. For example, as shown in FIG. 5, the remitter's account 104 may be held by sFSP's partner bank 522, while RIB account 128 may be held by RIB's partner bank 524, both of which are in the same jurisdiction as the sFSP 106. Similarly, the beneficiary's account 132 may be held by rFSP's partner bank 526, while the local RIB account accessible by the rFSP 120 is held by RIB partner's bank 528. Regardless of which entity actually holds a particular account according to these exemplary embodiments, it is only important that the various accounts be accessible by the relevant parties as described herein, i.e., that the FSPs have access to the end user accounts and the RIB accounts, and that the end users and the RIB have access to their respective accounts.

Turning now to FIG. 6, specific (yet still exemplary) forecasting calculations are performed by the RIB server 110 as shown by block 600. For example, the RIB server 110 can calculate a value X which is equal to the sum of the daily inter-currency transactions performed by sFSP 106, multiplied by the number of days between rebalancing events, multiplied by a risk factor. Assuming, for example, that the RIB account 128 regularly experienced a surplus as a net effect of end users regularly transferring money from the sFSP 106 to the rFSP 120, then the value X could represent the value which RIB server 110 estimates can be unloaded (transferred out) of RIB account 128.

Similarly, the RIB server 110 can calculate a value Y which is equal to the sum of the daily inter-currency transactions performed by the rFSP 120, multiplied by the number of days between rebalancing events, multiplied by a risk factor. Assuming, for example, that the RIB account 130 regularly experienced a deficit as a net effect of paying out to end users as a result of transfers money from the sFSP 106 to the rFSP 120, then the value Y could represent the value which RIB server 110 estimates needs to be loaded (transferred into) RIB account 130 in order to handle upcoming inter-currency transfers.

With this information, RIB server 110 can send, for example, a signal 602 toward sFSP 106 requesting a cash out be performed in the calculated amount X from RIB account 128. The sFSP server 106 can validate the request and create payment instructions to its partner bank 522 to transmit X to the RIB partner bank 524, which instructions are sent to the partner bank 522 via signal 606. The sFSP server 106 can also confirm that this payment was submitted via signal 608 back to RIB server 110. The RIB server 110 can then confirm this payment toward the Treasury 506 via incoming payment advisory signal 610, and the actual bank-to-bank transfer between the partner banks 522 and 524 is shown as action 612. Once the RIB partner bank 524 confirms receipt of the funds via signal 614, the Treasury 506 can confirm that this portion of the rebalancing has been successfully completed via signal 616 back to the RIB server 110.

Similarly, with respect to RIB account 130, RIB server 110 can send, for example, a rebalancing signal 618 toward Treasury 506 requesting that a refunding of account 130 be performed in the calculated amount Y. The Treasury 506 can validate the request and create payment instructions (step 620) to its partner bank 528 in the jurisdiction of the rFSP 120 to transmit Y to the rFSP partner bank 526, which instructions are sent to the partner bank 528 via signal 622. The Treasury 506 can also confirm that this payment was submitted via signal 624 back to RIB server 110. Once the actual bank-to-bank transfer between the partner banks 528 and 526 is performed, as shown by action 626, the RIB partner bank 528 can confirm that the funds were sent via signal 628 to the Treasury 506. The Treasury 506, in turn, can confirm that this portion of the rebalancing has been successfully completed via signal 630 back to the RIB server 110. Once the rFSP 120 validates that the transfer was successful via signal 632, then this portion of the rebalancing activity is complete.

Note that, as mentioned previously, the real money transfers which are effected by the rebalancing process shown in the exemplary embodiment of FIG. 6 need not be performed at the same time as the e-money flows described previously with respect to, for example, FIG. 4(d). The beneficiary party 102 of the inter-currency transaction can access the transferred funds in real time (or near real time) after step 478 and need not await the rebalancing or any other sort of bank settlement process to occur. This disassociation between the e-money and real money transfer provides several substantial advantages for inter-currency transfer methods and systems according to these exemplary embodiments. For example, from the perspective of the end user, funds are available quickly and easily upon instituting the transaction, while still being secure. For example, from the perspective of the FSPs, the transactions can be performed using legacy, local transaction mechanisms, with extremely low risk on their part and without needing to allocate their own capital reserves.

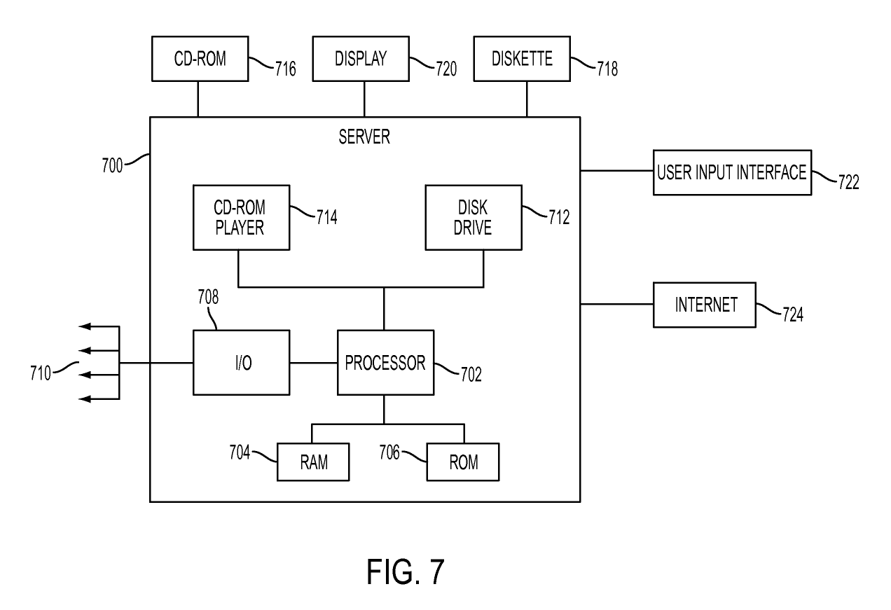

From the foregoing discussion, it will be appreciated that exemplary embodiments impact network nodes in currency transaction systems, e.g., FSP servers and RIB servers, and FIG. 7 provides an exemplary representation thereof. Therein, server 700 includes a central processor (CPU) 702 coupled to a random access memory (RAM) 704 and to a read-only memory (ROM) 706. The ROM 706 may also be other types of storage media to store programs, such as programmable ROM (PROM), erasable PROM (EPROM), etc. The processor 702 may communicate with other internal and external components through input/output (I/O) circuitry 708 and bussing 710, to provide control signals and the like, e.g., those signals described above with respect to FIGS. 4-6.

The server 700 may also include one or more data storage devices, including hard and floppy disk drives 712, CD-ROM drives 714, and other hardware capable of reading and/or storing information such as DVD, etc. In one embodiment, software for carrying out the above discussed steps and signal processing may be stored and distributed on a CD-ROM 716, diskette 718 or other form of media capable of portably storing information. These storage media may be inserted into, and read by, devices such as the CD-ROM drive 714, the disk drive 712, etc. The server 700 may be coupled to a display 720, which may be any type of known display or presentation screen, such as LCD displays, plasma display, cathode ray tubes (CRT), etc. A user input interface 722 can be provided, including one or more user interface mechanisms such as a mouse, keyboard, microphone, touch pad, touch screen, voice-recognition system, etc.

The server 700 may be coupled to other computing devices, such as the nodes described above, via a network. The server 700 may be part of a larger network configuration as in a global area network (GAN) such as the Internet 724, which allows ultimate connection to the various end user devices, e.g., landline phone, mobile phone, personal computer, laptop, etc.

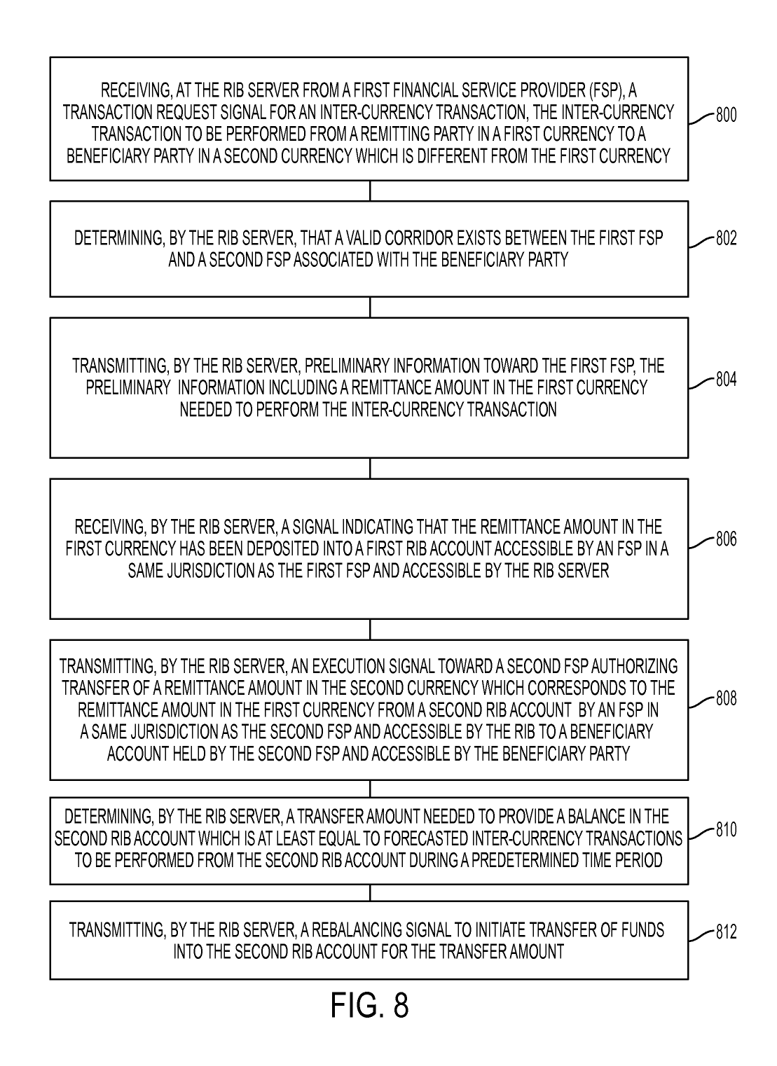

In operation, a RIB server can, according to an exemplary embodiment, perform an inter-currency transfer by performing the steps illustrated in FIG. 8. Therein, at step 800, the RIB server receives, from a first financial service provider (FSP), a transaction request signal for an inter-currency transaction, the inter-currency transaction to be performed from a remitting party in a first currency to a beneficiary party in a second currency which is different from the first currency. At step 802, the RIB server determines that a valid corridor exists between the first FSP and a second FSP associated with the beneficiary party. The RIB server transmits, at step 804, preliminary information toward the first FSP, the preliminary information including a remittance amount in the first currency needed to perform the inter-currency transaction. At step 806, the RIB server receives a signal indicating that the remittance amount in the first currency has been deposited into a first RIB account held by an FSP in a same jurisdiction as the first FSP and accessible by the RIB server.

Next, the RIB server transmits an execution signal toward a second FSP authorizing transfer of a remittance amount in the second currency which corresponds to the remittance amount in the first currency from a second RIB account held by an FSP in a same jurisdiction as the second FSP and accessible by the RIB to a beneficiary account held by the second FSP and accessible by the beneficiary party at step 808. A transfer amount is determined by the RIB server at step 810 which is needed to provide a balance in the second RIB account which is at least equal to forecasted inter-currency transactions to be performed from the second RIB account during a predetermined time period. At step 812, a rebalancing signal is transmitted by the RIB server 812 to initiate transfer of funds into the second RIB account for the transfer amount.

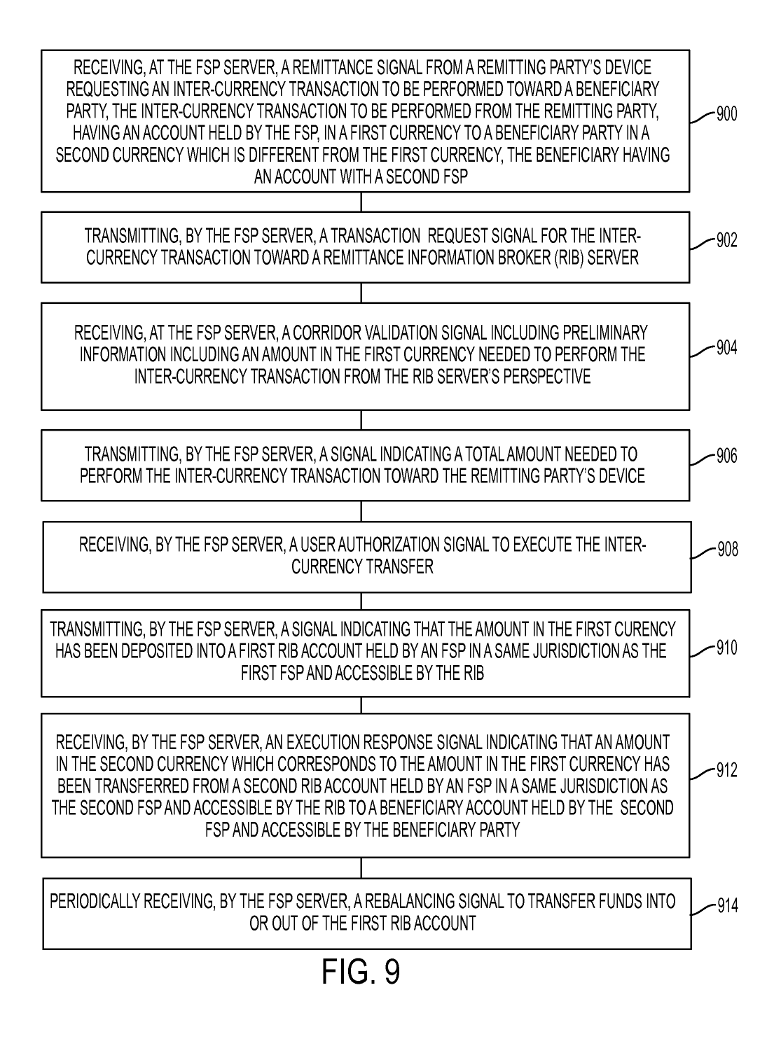

The server 700 can also operate as an FSP server. For example, when operating as the remitting (sending) sFSP server 106, server 700 can be configured to perform the steps illustrated in the flow chart of FIG. 9. Therein, at step 900, the FSP server receives a remittance signal from a remitting party's device requesting an inter-currency transaction to be performed toward a beneficiary party, the inter-currency transaction to be performed from the remitting party, having an account held by the FSP, in a first currency to a beneficiary party in a second currency which is different from the first currency, the beneficiary having an account with a second FSP. The FSP server transmits, at step 902, a transaction request signal for the inter-currency transaction toward a remittance information broker (RIB) server. The FSP server receives, at step 904, a corridor validation signal including preliminary information including an amount in the first currency needed to perform the inter-currency transaction from the RIB server's perspective.

At step 906, the FSP server transmits a signal indicating a total amount needed to perform the inter-currency transaction toward the remitting party's device. The FSP server then receives, at step 908, a user authorization signal to execute the inter-currency transfer. At step 910, the FSP server transmits a signal indicating that the amount in the first currency has been deposited into a first RIB account held by an FSP in a same jurisdiction as the first FSP and accessible by the RIB. The FSP server receives, at step 912, an execution response signal indicating that an amount in the second currency which corresponds to the amount in the first currency has been transferred from a second RIB account held by an FSP in a same jurisdiction as the second FSP and accessible by the RIB to a beneficiary account held by the second FSP and accessible by the beneficiary party. The FSP server also periodically receives rebalancing signal to transfer funds into or out of the first RIB account as shown by step 914.

In addition to servers, systems and methods for processing data according to exemplary embodiments of the present invention can be implemented as software, e.g., performed by one or more processors executing sequences of instructions contained in a memory device. Such instructions may be read into the memory device from other computer-readable mediums such as secondary data storage device(s). Execution of the sequences of instructions contained in the memory device causes the processor to operate, for example, as described above. In alternative embodiments, hard-wire circuitry may be used in place of or in combination with software instructions to implement the present invention.

The term “currency” has been used herein to refer to the types of transaction which are discussed with respect to exemplary embodiments. Alternatively, the term “monetary” could be used to replace “currency”.

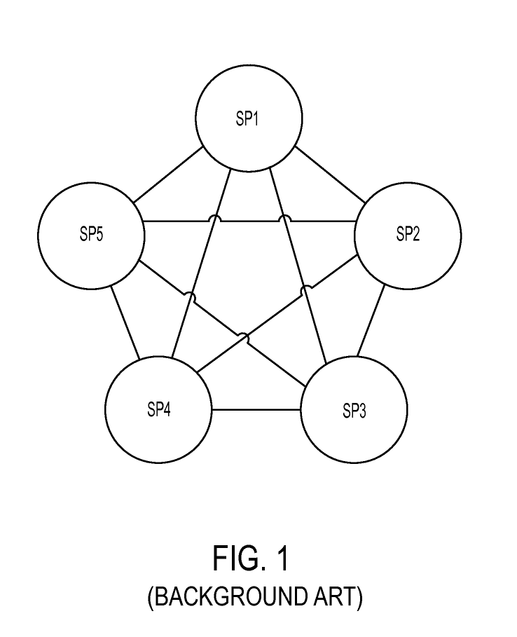

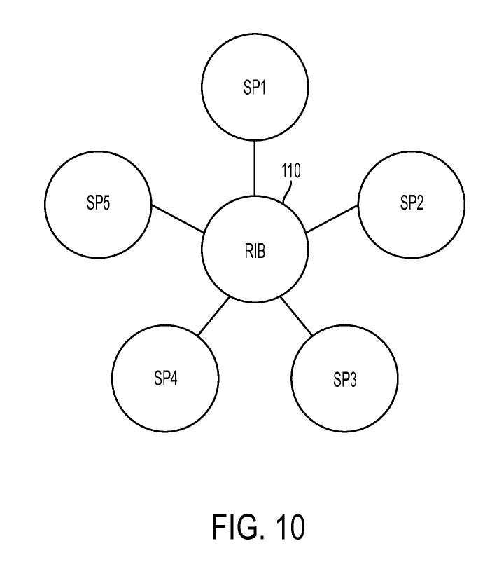

Numerous variants inter-currency transfer services are described herein. However as mentioned previously, exemplary embodiments are not limited to inter-currency transactions, i.e., transactions which involve a transfer from a first currency into a second currency which is different from the first currency. Instead, for example, currency transactions can be performed using the above-described embodiments between parties using the same currency at each end of the transaction. Regardless of the type(s) of currency used in the transaction, exemplary embodiments provide for a RIB server 110 which sits between the various FSPs as shown conceptually in FIG. 10. This enables, among other things, for each FSP to have only one interface for such transfers with the RIB 110, as opposed to needing to maintain numerous interfaces as shown in FIG. 1.

The above-described exemplary embodiments are intended to be illustrative in all respects, rather than restrictive, of the present invention. Thus the present invention is capable of many variations in detailed implementation that can be derived from the description contained herein by a person skilled in the art. All such variations and modifications are considered to be within the scope and spirit of the present invention as defined by the following claims. No element, act, or instruction used in the description of the present application should be construed as critical or essential to the invention unless explicitly described as such. Also, as used herein, the article “a” is intended to include one or more items.

What is claimed is:

1. A method for performing inter-currency transactions by a remittance information broker (RIB) server, the method comprising:
receiving, at said RIB server from a first financial service provider (FSP), a transaction request signal for an inter-currency transaction, said inter-currency transaction to be performed from a remitting party in a first currency to a beneficiary party in a second currency which is different from said first currency;
determining, by said RIB server, that a valid corridor exists between said first FSP and a second FSP associated with said beneficiary party;
transmitting, by said RIB server, information toward said first FSP, said information including a remittance amount in said first currency needed to perform said inter-currency transaction;
receiving, by said RIB server, a signal indicating that said remittance amount in said first currency has been deposited into a first RIB account accessible by said first FSP and by said RIB server;
transmitting, by said RIB server, an execution signal toward a second FSP authorizing transfer of a remittance amount in said second currency which corresponds to said remittance amount in said first currency from a second RIB account accessible by said second FSP and by said RIB server to a beneficiary account accessible by said second FSP and by said beneficiary party;
determining, by said RIB server, a transfer amount needed to provide a balance in said second RIB account which is at least equal to forecasted inter-currency transactions to be performed from said second RIB account during a time period; and
transmitting, by said RIB server, a rebalancing signal to initiate transfer of funds into said second RIB account for said transfer amount.

2. The method of claim 1, wherein said beneficiary party can access said remittance amount in said second currency in said account accessible by said second FSP and by said beneficiary party in real time or near real time relative to said transmission of said execution signal.

3. The method of claim 1, wherein said beneficiary party can access said remittance amount in said second currency in said account accessible by said second FSP and by said beneficiary party without a bank settlement process being performed for said transfer of said amount in said second currency.

4. The method of claim 1, further comprising:
determining that said beneficiary party exists at said second FSP; and
validating and authorizing said first FSP and said second FSP.

5. The method of claim 1, wherein said determining, by said RIB server, said transfer amount further comprises:
receiving, by said RIB server, a signal including average balance and minimum balance information for said first RIB account over a predetermined past time period; and
calculating, by said RIB server, a forecasted average balance and a forecasted minimum balance for said first RIB account over a predetermined future time period to determine said transfer amount

6. The method of claim 5, wherein said step of calculating, by said RIB server, said forecasted average balance and forecasted minimum balance to determine said transfer amount further comprises:
calculating said transfer amount as an average daily outflow of funds from said first RIB account multiplied by a number of days until a next funding event for said first RIB account, multiplied by a risk factor.

7. A remittance information broker (RIB) server which handles inter-currency transactions, said RIB server comprising:
an interface configured to transmit signals to a network and configured to receive signals from said network, said interface further configured to receive a transaction request signal from a first financial service provider (FSP) for an inter-currency transaction, said inter-currency transaction to be performed from a remitting party in a first currency to a beneficiary party in a second currency which is different from said first currency;
a processor configured to validate a corridor between said first FSP and said second FSP and further configured to transmit information toward said first FSP, said information including a remittance amount in said first currency needed to perform said inter-currency transaction;
wherein said interface is further configured to receive a signal indicating that said remittance amount in said first currency has been deposited into a first RIB account accessible said first FSP and by said RIB server;
wherein said processor is further configured to transmit an execution signal toward a second FSP authorizing transfer of a remittance amount in said second currency which corresponds to said amount in said first currency from a second RIB account accessible by said second FSP and by said RIB server to a beneficiary account accessible by said second FSP and by said beneficiary party; and
wherein said processor is further configured to determine a transfer amount needed to provide a balance in said second RIB account which is at least equal to forecasted inter-currency transactions to be performed from said second RIB account during a time period and to transmit a rebalancing signal to initiate transfer of funds into said second RIB account for said transfer amount.

8. The RIB server of claim 7, wherein said RIB server enables said beneficiary party to access said remittance amount in said second currency in said account accessible by said second FSP and by said beneficiary party in real time or near real time relative to said transmission of said execution signal.

9. The RIB server of claim 7, wherein said RIB server enables said beneficiary party to access said remittance amount in said second currency in said account accessible by said second FSP and by said beneficiary party without a settlement process being performed for said transfer of said amount in said second currency.

10. The RIB server of claim 7, wherein said processor is further configured to determine that said beneficiary party exists at said second FSP, and to validate and authorize said first FSP and said second FSP.

11. The RIB server of claim 7, wherein said interface is further configured to receive a signal including average balance and minimum balance information for said first RIB account over a predetermined past time period, and
wherein said processor is further configured to determine said transfer amount by calculating a forecasted average balance and a forecasted minimum balance for said first RIB account over a predetermined future time period.

12. The RIB server of claim 11, wherein said processor is further configured to determine said transfer amount by calculating said transfer amount as an average daily outflow of funds from said first RIB account multiplied by a number of days until a next prefunding event for said first RIB account, multiplied by a risk factor.

13. A method for performing inter-currency transactions by a financial service provider (FSP) server associated with a first FSP, the method comprising:
receiving, at said FSP server, a remittance signal from a remitting party's device requesting an inter-currency transaction to be performed toward a beneficiary party, said inter-currency transaction to be performed from said remitting party, having an account accessible by said FSP, in a first currency to a beneficiary party in a second currency which is different from said first currency, said beneficiary having an account accessible by a second FSP;
transmitting, by said FSP server, a transaction request signal for said inter-currency transaction toward a remittance information broker (RIB) server;
receiving, at said FSP server, a corridor validation signal including an amount in said first currency needed to perform said inter-currency transaction from said RIB server's perspective;
transmitting, by said FSP server, a signal indicating a total amount needed to perform said inter-currency transaction toward said remitting party's device;
receiving, by said FSP server, a user authorization signal to execute said inter-currency transfer;
transmitting, by said FSP server, a signal indicating that said amount in said first currency has been deposited into a first RIB account accessible by said first FSP and by said RIB;
receiving, by said FSP server, an execution response signal indicating that an amount in said second currency which corresponds to said amount in said first currency has been transferred from a second RIB account accessible by said second FSP and by said RIB to a beneficiary account accessible by said second FSP and by said beneficiary party; and
periodically receiving, by said FSP server, a rebalancing signal to transfer funds into or out of said first RIB account.

14. The method of claim 13, wherein said beneficiary party can access said amount in said second currency in said account accessible by said second FSP and by said beneficiary party in real time or near real time relative to said transmission of said execution signal.

15. The method of claim 13, wherein said beneficiary party can access said amount in said second currency in said account accessible by said second FSP and by said beneficiary party without a bank settlement process being performed for said transfer of said amount in said second currency.

16. The method of claim 13, wherein said information includes a foreign exchange rate associated with exchanging said first currency into said second currency and at least one fee associated with performing said inter-currency transaction.

17. The method of claim 13, further comprising:
calculating, by said FSP server, a fee associated with said inter-currency transaction to be charged by said first FSP.

18. A financial service provider (FSP) server associated with a first FSP which handles inter-currency transaction, the FSP server comprising:
an interface configured to receive a remittance signal from a remitting party's device requesting an inter-currency transaction to be performed toward a beneficiary party, said inter-currency transaction to be performed from said remitting party, having an account accessible by said FSP, in a first currency to a beneficiary party in a second currency which is different from said first currency, said beneficiary having an account accessible by a second FSP;
a processor configured to transmit a transaction request signal for said inter-currency transaction toward a remittance information broker (RIB) server;
wherein said interface is further configured to receive a corridor validation signal having information including an amount in said first currency needed to perform said inter-currency transaction from said RIB server's perspective;
wherein said processor is further configured to transmit a signal indicating a total amount needed to perform said inter-currency transaction toward said remitting party's device;
wherein said interface is further configured to receive a user authorization signal to execute said inter-currency transfer; and
wherein said processor is further configured to transmit a signal indicating that said amount in said first currency has been deposited into a first RIB account accessible by said first FSP and by said RIB server;
wherein said interface is further configured to receive an execution response signal indicating that an amount in said second currency which corresponds to said amount in said first currency has been transferred from a second RIB account accessible by said second FSP and by said RIB to a beneficiary account accessible by said second FSP and by said beneficiary party; and
wherein said interface is further configured to periodically receive a rebalancing signal to transfer funds into or out of said first RIB account.

19. The FSP server of claim 18, wherein said beneficiary party can access said amount in said second currency in said account accessible by said second FSP and by said beneficiary party in real time or near real time relative to said transmission of said execution signal.

20. The FSP server of claim 18, wherein said beneficiary party can access said amount in said second currency in said account accessible by said second FSP and by said beneficiary party without a bank settlement process being performed for said transfer of said amount in said second currency.

21. The FSP server of claim 18, wherein said information includes a foreign exchange rate associated with exchanging said first currency into said second currency and at least one fee associated with performing said inter-currency transaction.

22. A method for performing currency transactions by a remittance information broker (RIB) server, the method comprising:
receiving, at said RIB server from a first financial service provider (FSP), a transaction request signal for a currency transaction, said currency transaction to be performed from a remitting party to a beneficiary party;
determining, by said RIB server, that a valid corridor exists between said first FSP and a second FSP associated with said beneficiary party;
transmitting, by said RIB server, information toward said first FSP, said information including a remittance amount needed to perform said currency transaction;
receiving, by said RIB server, a signal indicating that said remittance amount has been deposited into a first RIB account accessible by said first FSP and by said RIB server;
transmitting, by said RIB server, an execution signal toward a second FSP authorizing transfer of a remittance amount from a second RIB account accessible by said second FSP and by said RIB server to a beneficiary account accessible by said second FSP and by said beneficiary party;
determining, by said RIB server, a transfer amount needed to provide a balance in said second RIB account which is at least equal to forecasted inter-currency transactions to be performed from said second RIB account during a predetermined time period; and
transmitting, by said RIB server, a rebalancing signal to initiate transfer of funds into said second RIB account for said transfer amount.

23. A method for performing monetary transactions by a remittance information broker (RIB) server, the method comprising:
receiving, at said RIB server from a first financial service provider (FSP), a transaction request signal for an inter-currency transaction, said inter-currency transaction to be performed from a remitting party to a beneficiary party;
transmitting, by said RIB server, information toward said first FSP, said information including a remittance amount needed to perform said transaction;
receiving, by said RIB server, a signal indicating that said remittance amount has been deposited into a first RIB account accessible by said RIB server; and
transmitting, by said RIB server, an execution signal toward a second FSP authorizing transfer of a remittance amount which corresponds to said remittance amount from a second RIB account and accessible by said RIB server to a beneficiary account accessible by said second FSP and by said beneficiary party.

24. Method according to claim 23 further comprising:
determining, by said RIB server, a transfer amount needed to provide a balance in said second RIB account which is at least equal to forecasted inter-currency transactions to be performed from said second RIB account during a time period; and
transmitting, by said RIB server, a rebalancing signal to initiate transfer of funds into said second RIB account for said transfer amount.
